(19) United States
(12) Patent Application Publication
(10) Pub. No.: US 2017/0006371 A1
(43) Pub. Date: Jan. 5, 2017

(54) WEDGE SHAPE HEADPHONES

(71) Applicant: Cheuk Ming Lam, Hong Kong (CN)

(72) Inventor: Cheuk Ming Lam, Hong Kong (CN)

(21) Appl. No.: 14/754,713

(22) Filed: Jun. 30, 2015

(51) Int. Cl. H04R 1/10

(52) U.S. Cl. CPC H04R 1/1075; H04R 1/1016

(57) ABSTRACT

Wedge shape headphone structures are disclosed. Wedge shape headphone structures can be constructed using plastics, metal, glass, or wood, which assembled a smooth tapered narrow audio outlet channel. The housing structures include two housing component to encompass a speaker unit and a conductor to transmit audio signals to the users. With the shape of narrowing size towards a pointed end, the audio signals can be transmitted to the ear canals in a more effective way and provide a better wearing experience to more people. A coating material can be added to tapering area of the housing structure.

### BACKGROUND OF THE INVENTION

In-ear headphones are small headphones (including earbuds) which are inserted in the ear canal of users. As the headphones housings are usually made of non-elastic materials, these headphones have to equip with a pair of generic or custom tips for better fitting to ear canals. The aforesaid headphone tips are usually made from silicone, rubber, foam, and other kind of soft materials. These tips usually are round shape and have a limited number of sizes and respective perimeters for the users to choose (e.g. Small. Medium, and Large). This invention of headphone structure has a tapered design on the housing with a continuous range of sizes and perimeters to provide more choices for the headphone users, especially those with rare shape or size ear canals.

With this invention, the users can choose to wear the earbuds with or without silicone tips (or other similar structures). This embodiment offers a new and useful solution to those users that cannot find a well fit earphone for themselves. This structure is designed not only to provide a continuous size solution but also to improve transmission of audio signals and sound waves effectively into the ear canal.

### FIELD OF THE INVENTION

This invention relates generally to structures and design of audio playing devices (such as earphones or headphones) and audio signal recording equipments.

### SUMMARY OF THE INVENTION

The invention pertains to a tapered (e.g. gradually narrowed to a pointed end) earphone housing structure that can be fit to different sizes and shapes of ear canals. The tapered housing structure can also be described as the structures with continuously variable perimeters at cross sections of the structures at different angles or positions. The tapered shape earphone structures is hereby disclosed.

Tapered structure of this invention refers to the pointed end of the housing with an audio signal outlet. The gradual change of perimeters over this structure can be described as a continuous range of perimeters scattered over the surface of the earbud housing. As a result, a boarder range of sizes can be offered to fit to different size of ear canal, the earphone will be less prone to falling out, more comfortable to the users, and better isolation to environment noises.

The tapered structures can be constructed using an insert assembly construction method. Two pieces of parts form a housing that can encompass a set of sound making module (e.g. speaker, conductor, filter, and other accessories). The two parts of housing can be joined together by adhesives or thermo welding method. A coating material is then painted on the tapered area of the housing to provide a smooth surface.

This invention can be used for a single left side earbud, a single right side earbud or for a pair of earbuds

### BRIEF DESCRIPTION OF THE SEVERAL VIEWS OF THE DRAWINGS

FIG. 1 is a perspective view of the housing having an earbud with a tapered pointed narrow end. This is the left hand side earbud of an earphone; the right hand side of earbud can be a mirror image of FIG. 1.

FIG. 1a is a top view of both left and right hand side of the housing.

FIG. 1b is a left side view of the housing shown in FIG. 1 and 1.

FIG. 1c is the bottom view of the housing shown in FIG. 1a.

FIG. 2-2a are assembly drawings (perspective view) of the components of earphones constructed in accordance with an embodiment of the present invention.

FIG. 2b is an assembly drawing (top view) of the components of earphones constructed in accordance with an embodiment of the present invention.

FIG. 3 is the demonstration drawing of the tapered areas (e.g. covered by the dot lines) on the housing of earphones constructed in accordance with an embodiment of the present invention; The dot lines show the sizes and perimeters of the housing increase gradually from the narrow end of housing to the wide end of housing.

FIG. 3a is showing the left side view of the tapered structure referred to in FIG. 1; FIG. 3b is showing the top view of the structure referred to in FIG. 1; FIG. 3c is showing the prospective view of the structure referred to in FIG. 1.

FIG. 4-4c are different illustrative views showing the structure of present invention with a soft material tip attached onto this invention structure. This invention can put into the ears with or without the soft material tip. FIG. 4a is left side view showing that the tapered area of the structure to be plugged into a soft earphone tip; FIG. 4b is rear side view of FIG. 4a; FIG. 4c is right side view of FIG. 4a; and FIG. 4d is rear prospective view of FIG. 4a.

FIG. 5-5c are assembly drawings showing how to install the soft material tip to the housing. FIG. 5a is prospective side view of installation process; FIG. 5b is left side view of FIG. 5a; FIG. 5c is top view of FIG. 5a.

### DETAILED DESCRIPTION OF THE DISCLOSURE

Headphones or earbuds for use in headsets are disclosed. Earbuds according to embodiments of this invention include a tapered shape housing having a directional sound outlet. The housing has one or more pointed end. The housing can have a progressively enlarging shape starting from the sound outlet towards a blunt end. The earbuds can be constructed to have such a shape by combining two or more parts together to form part of the earbud. As will be explained in more detail below, the earbuds can be constructed using an injection molding method or die casting mothod to produce two or more than two half parts according to the centre axis of the earbuds that are then mated together. Other construction methods include producing two halves from the front and rear end halves or top and bottom half according to the centre axis of the design. These construction methods will set up a cavity inside the earbuds for the speakers unit and other acoustic parts. The speaker unit can be activated by electric or mechanical mechanism.

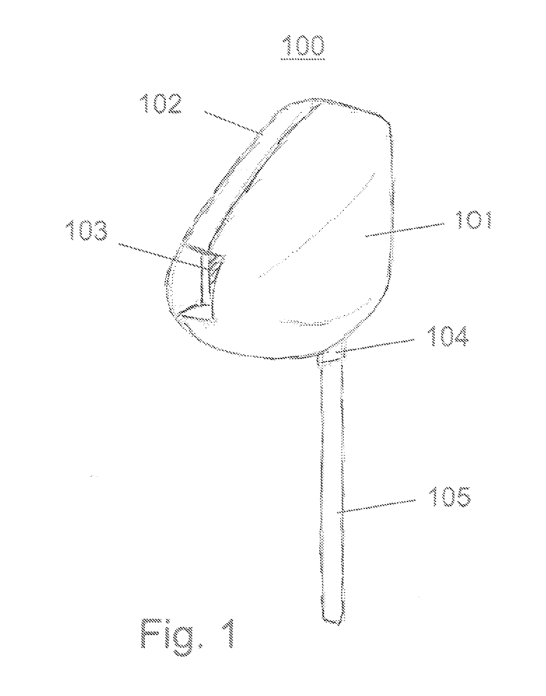

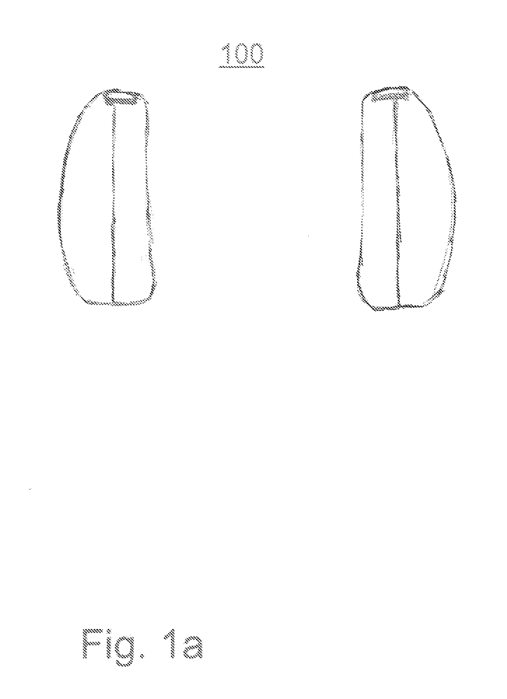

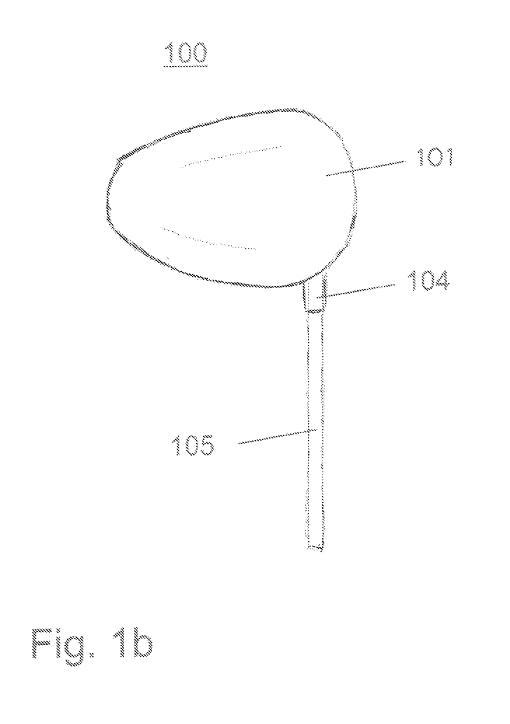

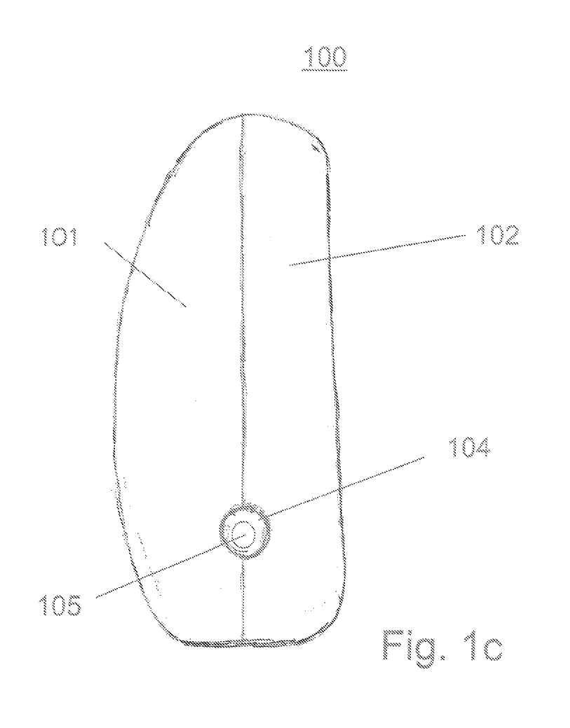

FIG. 1 shows an illustrative perspective view of earbud 100 in accordance with an embodiment of the invention. As shown in FIG. 1, this earbud 100 can include two complementary pieces 101 and 102 for the housing, filter 103, conductor protector 104, and external conductor 105. Earbud 100 can also include a speaker unit (not shown in FIG. 1) for making sound wave. The speaker unit can be composed of one or more drivers, subwoofers, coaxial drivers or any other acoustic accessories. FIG. 1a shows a pair of left and right housing for each set of earbud headset from the top view. The sound outlet can be seen on the top of the drawings in FIG. 1a. FIG. 1b shows the left side prospective view of the invention and the continuously increase in size can be seen from this angle of view. FIG. 1c shows the bottom side view of the invention and another angle of continuously increase in size can be seen in this angle of view. Earbud 100 in FIG. 1-1c is designed to fit in the ear of a user in a smooth manner. When the earbud housing is inserted in the ear along with the direction of putting sound outlet first into the ear canal and followed with smooth surfaces on the tapered area and leave the larger part of the housing outside the ear canal, it will consequently direct the sound into the user's ear canal.

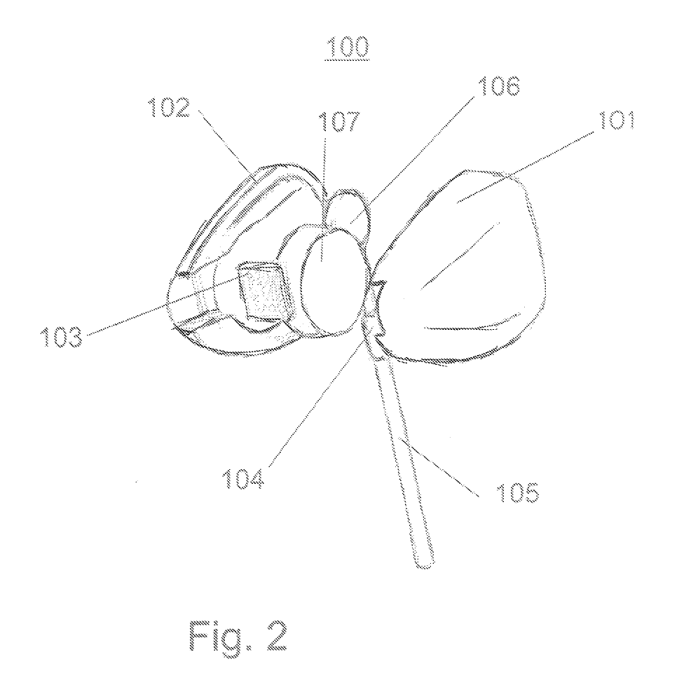

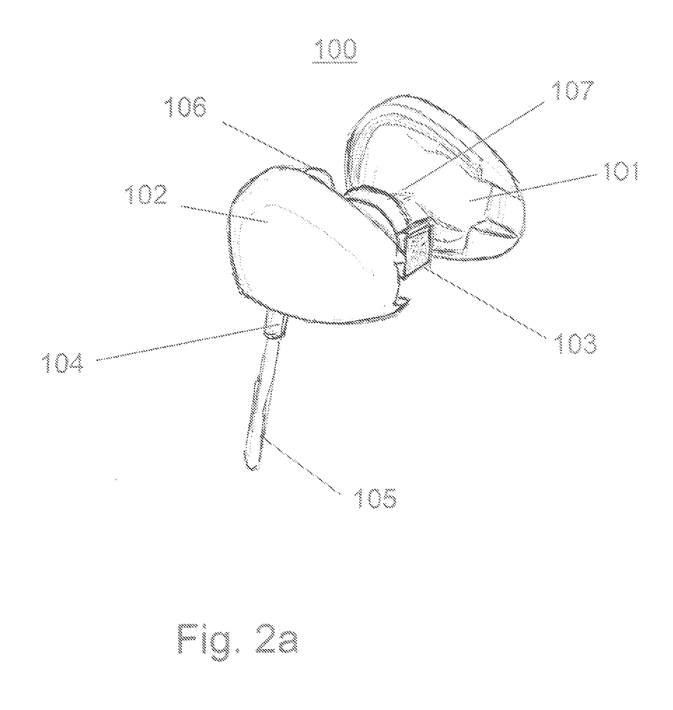

Referring now to FIG. 2, the assembly perspective view of earbud 100 is discussed. FIGS. 2-2b show illustrative assembly views taken respectively, of the positive forty-five degrees, the negative forty-five degrees view, and top view of earbud 100. The FIG. 2-2b shows this housing provides a cavity for the speaker unit 107, internal conductor 106, and filters 103 to install and to mount.

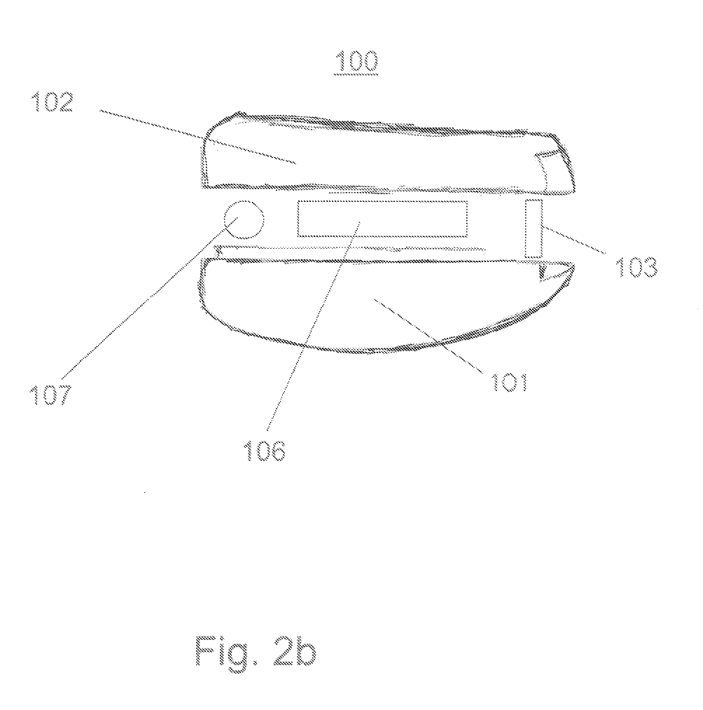

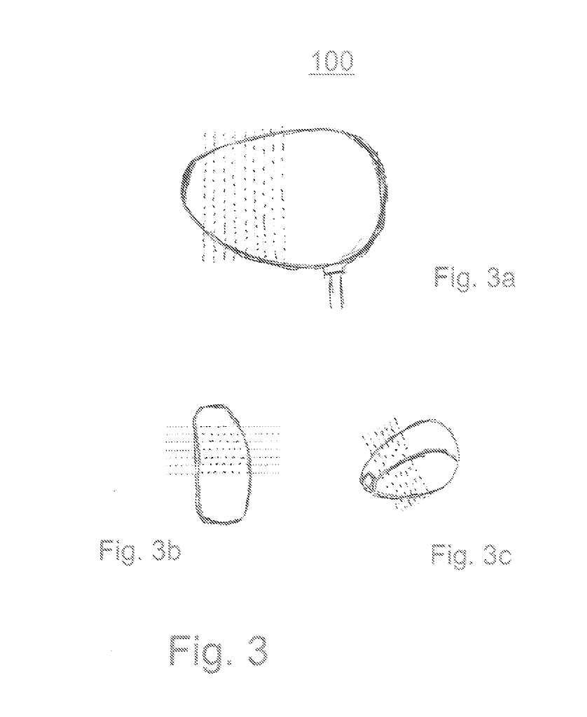

FIG. 3 shows several illustrative views of earbud 100 in accordance with an embodiment of the invention. In particular, FIG. 3 shows a side, top, and perspective views of earbud 100. The dotted lines highlight the continuous enlargement of the perimeters at a stepless way on the outer surface of tapered end (the sound outlet side) of earbud 100. As shown in FIG. 3a-3c, the related surface area of earbud 100 can provide gradually increasing sizes to fit the ear size either from a side, top, and front perspective views.

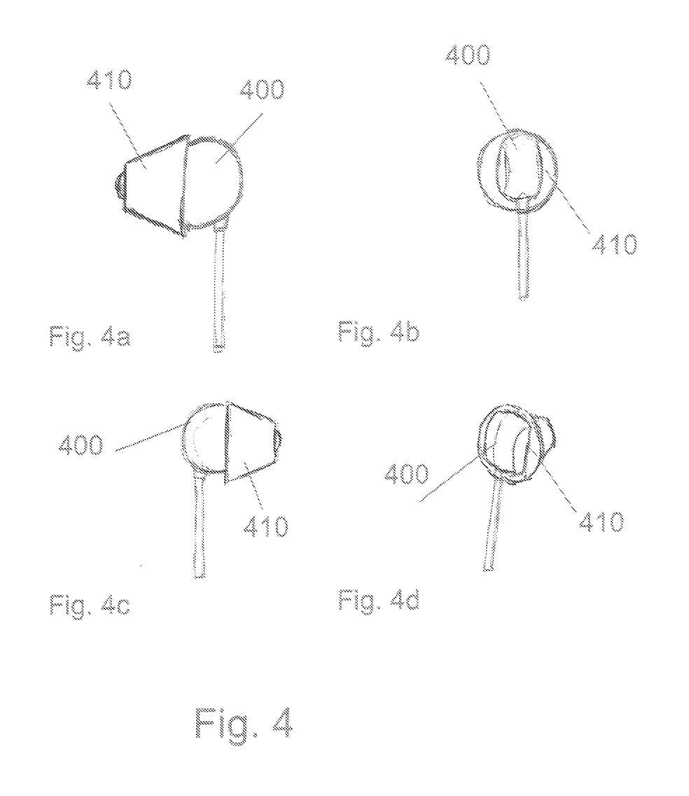

FIG. 4 show the earbud embodiments 400 can cap a earbud tip 410 at the narrow end of the earbud embodiments 400 The earbud 400 in the FIG. 4 refers to the earbud 100 in the FIG. 1. That is, the earbuds are able to have a construction to add an earbud tip on the external area of the housing. FIG. 4a-4d shows a left side, back, right, and perspective views of earbud 400 with a headphone tip 410.

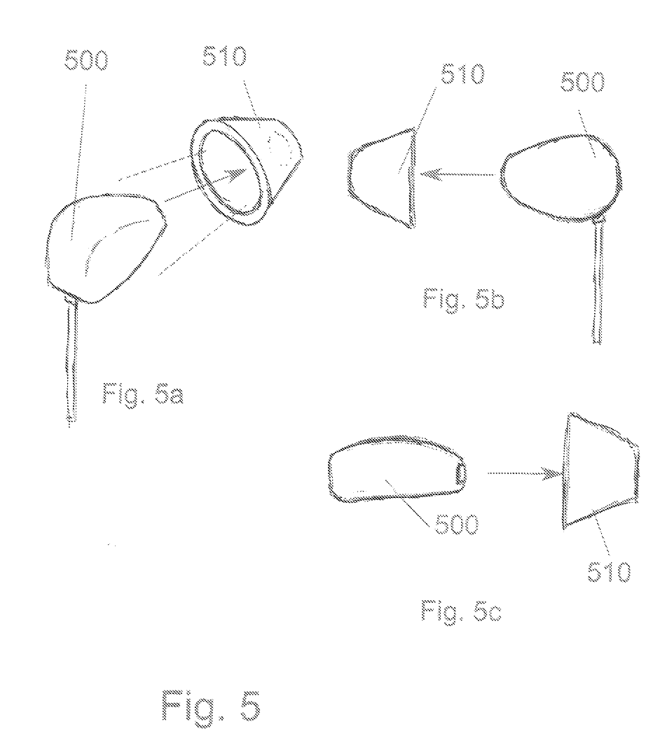

FIG. 5 shows an illustrative insert process of the earbud with the headphone tips. The tip and the earbud structure should be oriented in the position should in FIG. 5 and insert the earbud 500 into the tip 510. The assembly process can be made by hands for easy installation. The earbud 500 in the FIG. 5 refers to the earbud 100 in the FIG. 1. FIGS. 5a-5c show different illustrative views of the process.

The housing part 101 and 102 in FIG. 2 can be constructed using any suitable material such as metal, plastic or wood and is configured to mate with each other. When enclosures 101 and 102 are mated, they form a housing 100.

Although not shown in FIGS. 2-2b, the housing 101 and 102 can include internal features such as a speaker assembly engagement region or one or more acoustic volume parts. Housing 100 can accommodate speaker unit 107, internal conductor 106, filter 103, and other components (not shown) if necessary.

In FIG. 2, a part of conductor is assembled into the cavity created by 101 and 102. Conductor 106 can include any suitable conductors for enabling transmission of signals or conduction of power. Conductor can be wholly surrounded by the housing or only part of it is surrounded. One or more anti-tangle rods 104 that help to resist deformation or damage to the conductor medium can be installed. The speaker combo 106 and any other sound making parts can be assembled before insertion to the retention space within the housing 101 and 102. The housing has the space to retend the speaker combo 107, the filter 103, and the internal conduction 106 in place during assembly. The speaker combo, filter and conductors can be mounted on the housing. If desired, additional structures (e.g. additional filter and dampers) or circuitry can be mounted within the housing.

Then, the housing may be mated together using an adhesive, weld, or chemical bond. An advantage of constructing an earbud with two housing parts 101 and 102 is that the perfection of assembly work can be examined before combination of two or more parts. High level of perfection of this process will prevent the damage of electric parts such as the speaker unit. Such a fit assembly finishing also enables high quality painting outlook of coating on the housing of the earbud.

The described embodiments of the invention are presented for the purpose of illustration and not of limitation.

What is claimed is:

1. An earbud, comprising:
speaker unit;
conductor material connected the speaker unit to audio signal source;
one piece of housing component is mated to another piece of housing component to build up an earbud housing with a cavity to accommodate a speaker and a conductor material;
a sound outlet on the earbud housing; and
a filter installed at the sound outlet of earbud housing.

2. The earbud of claim 1, wherein the two housing components are combined to form the earphone housing.

3. The earbud of claim 1, wherein the two housing components are constructed to form a closed chamber for the speaker to emit the audit signals directionally from a sound outlet.

4. The earbud of claim 1, wherein the earbud housing has a body structure for mounting the speaker.

5. The earbud of claim 1, wherein the earbud housing has a narrow end that the sound comes out from the earbud.

6. The earbud of claim 1, wherein the narrow end of the earbud housing has a tapered structure. The narrow end gradually decreased in size or perimeter toward the sound outlet. The tapered structure can be a single or combinations of different tapered structures.

7. The earbud of claim 1, wherein a tapered structure in claim 6 is used for holding the earphone housing in the ear canal of the user.
